(19) United States
(12) Patent Application Publication
(10) Pub. No.: US 2026/0331816 A1
(43) Pub. Date: Oct. 22, 2026

(54) ROTATIONALLY ASSEMBLED FIXING STRUCTURE FOR HIGH-SPEED AUTOMOTIVE ELECTRICAL CONNECTOR

(71) Applicant: Sichuan Yonggui Science and Technology Co., Ltd., Mianyang, Sichuan (CN)

(72) Inventors: Siqi Cai, Mianyang, Sichuan (CN); Shemin Cai, Mianyang, Sichuan (CN); Dong Li, Mianyang, Sichuan (CN); Jinquan Yang, Mianyang, Sichuan (CN); Yanjun Zhang, Mianyang, Sichuan (CN); Yuanjun Wu, Mianyang, Sichuan (CN); Xinming Pu, Mianyang, Sichuan (CN)

(73) Assignee: Sichuan Yonggui Science and Technology Co., Ltd., Mianyang, Sichuan (CN)

(21) Appl. No.: 19/108,957

(22) PCT Filed: Oct. 31, 2024
(86) PCT No.: PCT/CN2024/128708

§ 371 Date: Mar. 5, 2025

(30) Foreign Application Priority Data
Nov. 7, 2023 (CN) 202322992822.X

(51) Int. Cl. H01R 13/502

(52) U.S. Cl. CPC H01R 13/502; H01R 2201/26

(57) ABSTRACT

A rotationally assembled fixing structure for a high-speed automotive electrical connector is provided, which includes a first housing and a second housing. At least one hole is formed inside the first housing, at least one first run-through feature is arranged inside the hole, the second housing is provided with at least one cylinder, at least one second run-through feature is arranged inside the cylinder, at least one first non-return feature and at least one first anti-rotating feature are arranged inside the hole, and an outer side of the cylinder is provided with at least one second non-return feature and at least one second anti-rotating feature; the first non-return feature and the second non-return feature interact to prevent the first housing and the second housing from being separated; and the first anti-rotating feature and the second anti-rotating feature interact.

### CROSS REFERENCE TO RELATED APPLICATION

This application is a national stage application of International Patent Application No. PCT/CN 2024/128708, filed on Oct. 31, 2024, which claims the priority of Chinese Patent Application No. 202322992822.X entitled “ROTATIONALLY ASSEMBLED FIXING STRUCTURE FOR HIGH-SPEED AUTOMOTIVE ELECTRICAL CONNECTOR” filed with the Chinese Patent Office on Nov. 7, 2023, which is incorporated herein by reference in its entirety.

### TECHNICAL FIELD

The present disclosure relates to the technical field of automotive connectors, and in particular to a rotationally assembled fixing structure for a high-speed automotive electrical connector.

### BACKGROUND

An automotive connector is applied at a blocked part in a circuit or between isolated circuits, and a bridge of communication is built by the connector, such that current flows and the circuits can achieve their intended functions. With people's increasing demands on such as cars in terms of safety, environmental friendliness, comfort, intelligence, the application of automotive electronic products is increasing day by day, the application of automotive connectors is growing accordingly, and the requirements for structural design, appearance design and materials of the automotive connectors are getting higher and higher.

A board-to-board connector for Ethernet signal transmission, known to the inventor, includes: a metal conductive housing, the metal conductive housing having a front end provided with hollow plug posts in the form of an array and a rear end being a conductive housing body; a plastic shell, the plastic shell being fixedly connected to the conductive housing body and sleeved on a periphery of the plug post; at least one long terminal assembly, the long terminal assemblies being arranged in the upper row of plug posts; at least one short terminal assembly, the short terminal assemblies being arranged in the lower row of plug posts; and a shielding housing arranged at a rear end of the conductive housing body; where the long terminal assembly includes a long terminal and a long insulating colloid integrally molded therewith in an embedding manner, the conductive housing body is provided with multiple positioning grooves, the plastic shell is provided with multiple positioning posts, and the conductive housing body engages with the plastic shell through the positioning grooves and the positioning posts.

However, since the engagement between the metal conductive housing and the plastic shell of the board-to-board connector described above can only achieve one direction of assembly, various parts need to be manufactured for finished products with different directions of assembly, resulting in high manufacturing and assembling costs.

### SUMMARY

In order to solve the problem that since the engagement between the metal conductive housing and the plastic shell of the board-to-board connector described above can only achieve one direction of assembly, various parts need to be manufactured for finished products with different directions of assembly, resulting in high manufacturing and assembling costs, the present disclosure provides a rotationally assembled fixing structure for a high-speed automotive electrical connector.

In order to achieve the objective described above, the present disclosure provides the following technical solutions.

A rotationally assembled fixing structure for a high-speed automotive electrical connector includes a first housing and a second housing. At least one hole is formed inside the first housing, at least one first run-through feature is arranged inside the at least one hole, the second housing is provided with at least one cylinder, and at least one second run-through feature is arranged inside the at least one cylinder. At least one first non-return feature and at least one first anti-rotating feature are arranged inside the at least one hole, and an outer side of the at least one cylinder is provided with at least one second non-return feature and at least one second anti-rotating feature.

The at least one first non-return feature and the at least one second non-return feature interact to prevent the first housing and the second housing from being separated.

The at least one first anti-rotating feature and the at least one second anti-rotating feature interact to prevent the first housing and the second housing from rotating.

In an exemplary embodiment, the at least one first anti-rotating feature includes a first lug, a second lug and a first recess, the first lug and the second lug are arranged on a side wall, away from the second housing, of the at least one first non-return feature, and the first recess is located between the first lug and the second lug.

In an exemplary embodiment, an inner wall of the first housing provided with the at least one hole is provided with multiple second recesses, multiple first non-return features are provided, one of the multiple second recesses is arranged between two adjacent first non-return features of the multiple first non-return features, and the first recess of one of the at least one first anti-rotating feature is in communication with the second recess, adjacent to the second lug, of a same one of the at least one first anti-rotating feature.

In an exemplary embodiment, a side wall, connected to the second lug, of the at least one first non-return feature is provided with a first bevel, and the first bevel is arranged at an end, adjacent to the second lug, of the at least one first non-return feature.

In an exemplary embodiment, an outer wall of the at least one cylinder is provided with at least one third lug, the at least one second non-return feature is a non-return surface, and the non-return surface is an end surface, away from the first housing, of the at least one third lug.

In an exemplary embodiment, an end surface of the non-return surface is provided as a second bevel.

In an exemplary embodiment, the at least one second anti-rotating feature includes a first anti-rotating surface and a second anti-rotating surface, and the first anti-rotating surface and the second anti-rotating surface are respectively opposite side walls of a corresponding one of the plurality of third lugs.

In an exemplary embodiment, a side wall of each of multiple the third lugs away from one of the multiple third lugs opposite thereto includes a third bevel and an arc surface, and a height of an end portion, away from the arc surface, of the third bevel is less than a height of an end portion, away from the third bevel, of the arc surface.

In an exemplary embodiment, a number of the at least one first non-return feature is set corresponding to a number of the at least one second non-return feature.

In an exemplary embodiment, a number of the at least one first anti-rotating feature is set corresponding to a number of the at least one second anti-rotating feature.

Compared with the conventional technology, the embodiments have the following beneficial effects.

According to the embodiments, one group of first non-return features and first anti-rotating features interact with different groups of second non-return features and second anti-rotating features to obtain a finished product with various directions of assembly, which reduces the variety of parts, lowers the manufacturing and assembling costs, also simplifies the assembly structure and improves the reliability of the connection structure.

### BRIEF DESCRIPTION OF THE DRAWINGS

FIG. 1 is a schematic diagram of an overall structure according to one or more embodiments;

FIG. 2 is a schematic diagram of a first housing according to one or more embodiments;

FIG. 3 is a schematic diagram of a second housing according to one or more embodiments;

FIG. 4 is a schematic diagram of the second housing according to one or more embodiments in a different perspective from FIG. 3;

FIG. 5 is a schematic diagram of different directions of assembly according to one or more embodiments; and

FIG. 6 is a schematic diagram of different directions of assembly when a single cylinder is arranged inside the second housing according to one or more embodiments.

### LIST OF REFERENCE CHARACTERS

1 first housing; 11 hole; 12 first non-return feature; 121 first bevel; 13 first anti-rotating feature; 131 first lug; 132 second lug; 133 first recess; 14 second recess; 15 first run-through feature; 2 second housing; 21 cylinder; 22 second run-through feature; 23 engaging member; 231 third lug; 232 second non-return feature; 233 second anti-rotating feature; 234 non-return surface; 235 first anti-rotating surface; 236 second anti-rotating surface; 237 second bevel; 238 third bevel; and 239 arc surface.

### DETAILED DESCRIPTION OF THE EMBODIMENTS

The technical solutions of the present disclosure will be clearly described below with reference to drawings. Apparently, the described embodiments are not all the embodiments of the present disclosure, any other embodiment obtained by those of ordinary skill in the art without creative work shall fall within the scope of protection of the present disclosure. It should be noted that the orientation or positional relationships indicated by the technical terms “center”, “upper”, “lower”, “left”, “right”, “vertical”, “horizontal”, etc. are based on the orientation or positional relationships shown in the accompanying drawings and are merely for ease of description of the present disclosure and simplification of the description, rather than indicating or implying that the devices or elements referred to must have a specific orientation or be constructed and operated in a specific orientation, and therefore cannot be construed as limiting the present disclosure.

### Embodiment I

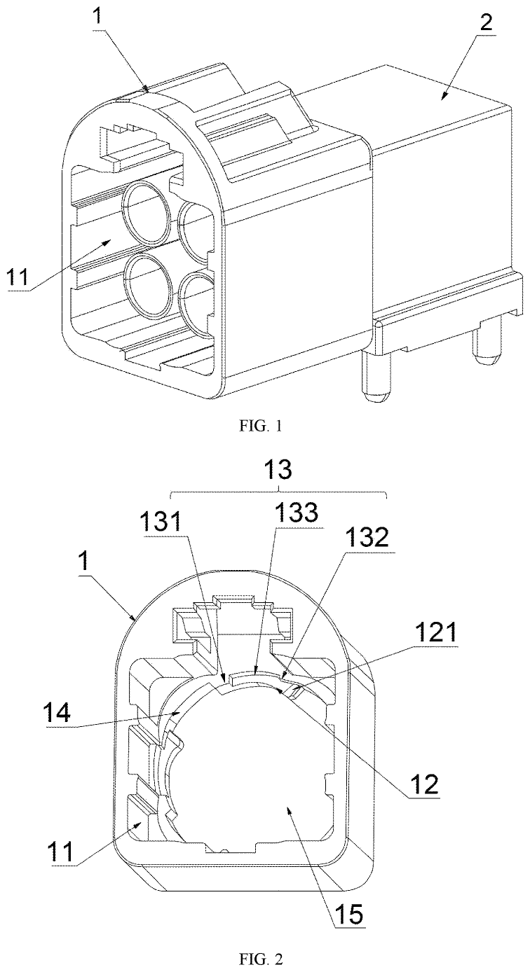

As shown in FIGS. 1, 2, 3 and 4, this embodiment provides a rotationally assembled fixing structure for a high-speed automotive electrical connector, including a first housing 1 and a second housing 2. At least one hole 11 is formed inside the first housing 1, and at least one first run-through feature 15, at least one first non-return feature 12 and at least one first anti-rotating feature 13 are arranged inside the hole 11 of the first housing 1. The second housing 2 is provided with at least one cylinder 21, at least one second run-through feature 22 is arranged inside the cylinder 21, and an outer side of the cylinder 21 is provided with at least one second non-return feature 232 and at least one second anti-rotating feature 233. The cylinder 21 of the second housing 2 penetrates the interior of the first run-through feature 15 of the first housing 1, the second housing 2 is rotated by a certain angle, the first non-return feature 12 and the second non-return feature 232 interact to prevent the cylinder 21 of the second housing 2 from being separated from the interior of the first housing 1, and at the same time, the first anti-rotating feature 13 and the second anti-rotating feature 233 interact to prevent the second housing 2 from rotating relative to the first housing 1.

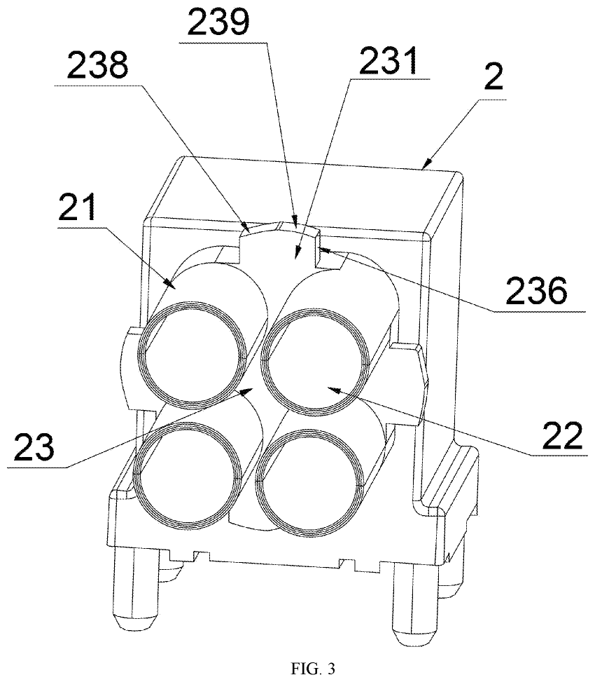

As shown in FIG. 2, the first run-through feature 15 is located at the end, adjacent to the second housing 2, of the inner wall of the first housing 1 provided with the hole 11. The first non-return feature 12 is an arc block. Preferably, 4 first non-return features 12 are provided, and the 4 first non-return features 12 are arranged circumferentially at intervals along the inner wall of the first housing 1. The first non-return features 12 are arranged at the end portion, adjacent to the second housing 2, of the inner wall of the first housing 1 at the hole 11. Preferably, the 4 first non-return features 12 are distributed in four directions, that are upper, lower, left and right, of the inner wall of the first housing 1, and a second recess 14 is formed between every two adjacent first non-return features 12. The first anti-rotating feature 13 includes a first lug 131, a second lug 132 and a first recess 133. Both of the first lug 131 and the second lug 132 are arranged on a side wall, away from the second housing 2, of the first non-return feature 12. The first recess 133 is arranged between the first lug 131 and the second lug 132. The first recess 133 is in communication with the second recess 14 adjacent to the second lug 132. The width of the end of the first non-return feature 12 corresponding to the second lug 132 is greater than the width of the end corresponding to the first lug 131. An end surface of the first non-return feature 12 connected to the second lug 132 is provided as a first bevel 121 arranged at an end portion adjacent to the second lug 132.

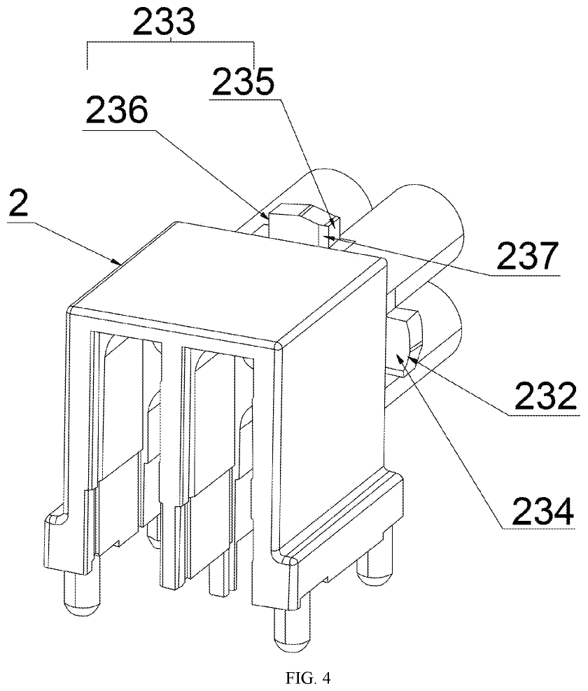

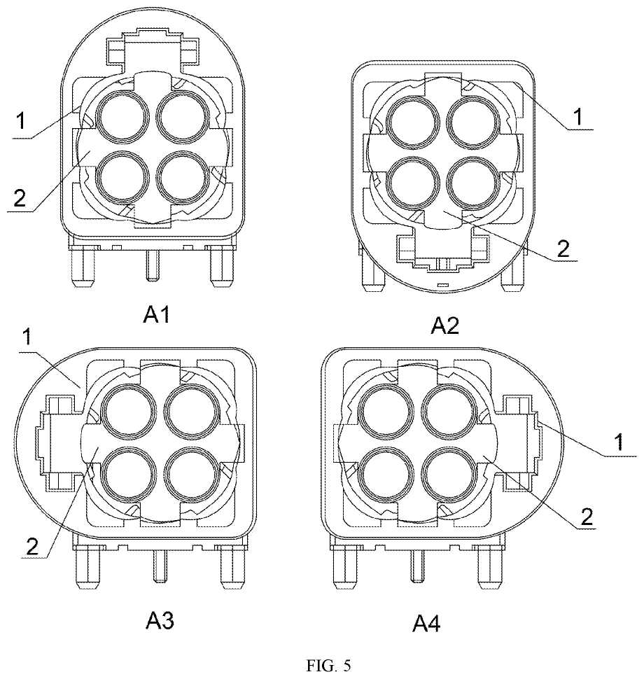

As shown in FIG. 3 and FIG. 4, preferably, four cylinders 21 are provided, an engaging member 23 is arranged among the four cylinders 21, the engaging member 23 is provided with multiple third lugs 231, preferably four third lugs 231, one third lug 231 is arranged between every two adjacent cylinders 21, and the third lug 231 extends out of every two adjacent cylinders 21. The second non-return feature 232 is a non-return surface 234, and the non-return surface 234 is a side surface of the third lug 231 away from the first housing 1. The second anti-rotating feature 233 includes a first anti-rotating surface 235 and a second anti-rotating surface 236, the first anti-rotating surface 235 and the second anti-rotating surface 236 are respectively two side surfaces of the third lug 231 adjacent to its adjacent third lugs 231, and the first anti-rotating surface 235 of any one of the third lugs 231 is adjacent to the second anti-rotating surface 236, adjacent to this first anti-rotating surface 235, of another third lug 231.

As shown in FIG. 3, the end surface of the third lug 231 away from its opposite third lug 231 includes a third bevel 238 and an arc surface 239, the third bevel 238 is arranged adjacent to the first lug 131 in the corresponding first anti-rotating feature 13 of the third lug 231 where the third bevel is located, and the height of the end, adjacent to the first lug 131, of the first bevel 121 is less than the height of the end, away from the first lug 131, of the arc surface 239.

As shown in FIG. 4, the end of the non-return surface 234 adjacent to the first lug 131 in the corresponding first anti-rotating feature 13 of the third lug 231 where the non-return surface is located is provided with a second bevel 237, and the second bevel 237 is arranged in a direction opposite to the direction in which the second housing 2 is inserted into the first housing 1, from the end adjacent to the first lug 131 to the end away from the first lug 131.

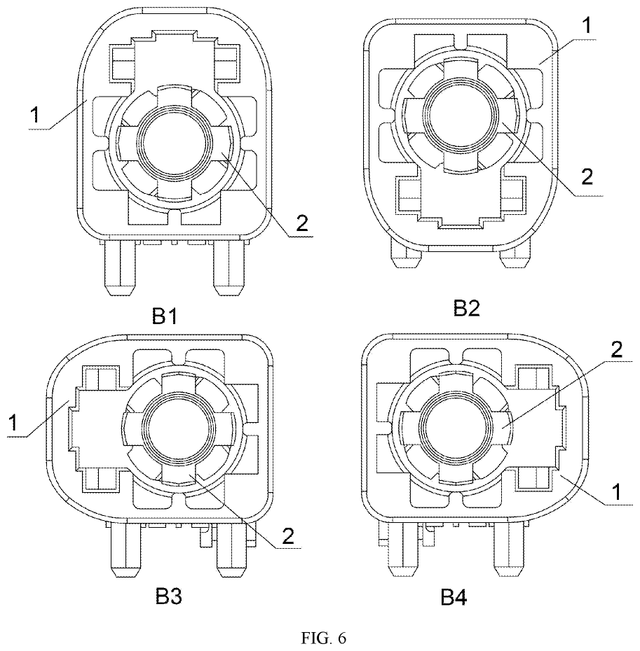

The working principle of the rotationally assembled fixing structure for the high-speed automotive electrical connector is described as below. After the cylinder 21 of the second housing 2 corresponds to the first run-through feature 15 of the first housing 1, the third lug 231 is correspondingly stretched into the second recess 14, and the second housing 2 is rotated in a direction of approaching the first recess 133 in communication with the second recess 14. In this process, the second bevel 237 of the third lug 231 is first in contact with the first bevel 121 of the first non-return feature 12, and the third bevel 238 of the third lug 231 is in contact with a lower wall of the second lug 132. A portion corresponding to the third bevel 238 of the third lug 231 first enters the interior the first recess 133, and the second housing 2 is then vigorously rotated. The arc surface 239 of the third lug 231 enters the interior of the first recess 133 after abutting against the second lug 132. The third lug 231 is located behind the first recess 133. The non-return surface 234 is in contact with an end surface, away from the second housing 2, of the first non-return feature 12. The first anti-rotating surface 235 is in contact with a side wall, adjacent to the second lug 132, of the first lug 131. The second anti-rotating surface 236 is in contact with a side wall, adjacent to the first lug 131, of the second lug 132. Therefore, the first housing 1 and the second housing 2 can be prevented from separation, and the first housing 1 and the second housing 2 can also be prevented from rotating. Further, the assembly of the first housing 1 and the second housing 2 shown in FIG. 1 is only one assembly mode of this embodiment. As shown in FIG. 5A-FIG. 5D, the direction of assembly shown in FIG. 5A is the direction of assembly shown in FIG. 1, the direction of assembly shown in FIG. 5B is the result of assembly after the first housing 1 in FIG. 5A is rotated clockwise by 180 °, the direction of assembly shown in FIG. 5C is the result of assembly after the first housing 1 in FIG. 5A is rotated counterclockwise by 90 °, and the direction of assembly shown in FIG. 5D is the result of assembly after the first housing 1 in FIG. 5A is rotated clockwise by 90 °. As shown in FIG. 5A-FIG. 5D, in this embodiment, finished products with various directions of assembly can be obtained, thereby reducing the variety of parts, lowering the manufacturing and assembling costs, simplifying the assembly structure and improving the reliability of the connection structure.

As shown in FIG. 6A-FIG. 6D, when the interior of the second housing 2 is in a single-cylinder state, there are also four assembly modes of the first housing 1 and the second housing 2. The direction of assembly shown in FIG. 6A is the same as the direction of assembly shown in FIG. 5A. The direction of assembly shown in FIG. 6B is the result of assembly after the first housing 1 in FIG. 6A is rotated clockwise by 180 °. The direction of assembly shown in FIG. 6C is the result of assembly after the first housing 1 in FIG. 6A is rotated counterclockwise by 90 °. The direction of assembly shown in FIG. 6D is the result of assembly after the first housing 1 in FIG. 6A is rotated clockwise by 90 °.

### Embodiment II

This embodiment relates to modifications made on the basis of Embodiment I, and mainly differs from Embodiment I in the followings. In this embodiment, two or three holes 11 may be formed inside the first housing 1, three or five first non-return features 12 may be arranged inside any one of the holes 11, and the first anti-rotating features 13 are arranged corresponding to the first non-return features 12; and there may be three or five cylinders 21 arranged corresponding to any one of the holes 11, and the engaging member 23 among the multiple cylinders 21 may be provided with three or five third lugs 231.

Finally, it should be noted that the above description is only intended to illustrate the technical solutions of the present disclosure but not to limit the scope of protection of the present disclosure, and simple modifications or equivalent substitutions made by those of ordinary skill in the art to the technical solutions of the present disclosure will not depart from the essence or the scope of the technical solutions of the present disclosure.

What is claimed is:

1. A rotationally assembled fixing structure for a high-speed automotive electrical connector, comprising a first housing (1) and a second housing (2), wherein at least one hole (11) is formed inside the first housing (1), at least one first run-through feature (15) is arranged inside the at least one hole (11), the second housing (2) is provided with at least one cylinder (21), and at least one second run-through feature (22) is arranged inside the at least one cylinder (21);
wherein at least one first non-return feature (12) and at least one first anti-rotating feature (13) are arranged inside the at least one hole (11), and an outer side of the at least one cylinder (21) is provided with at least one second non-return feature (232) and at least one second anti-rotating feature (233);
wherein the at least one first non-return feature (12) and the at least one second non-return feature (232) interact to prevent the first housing (1) and the second housing (2) from being separated; and
wherein the at least one first anti-rotating feature (13) and the at least one second anti-rotating feature (233) interact to prevent the first housing (1) and the second housing (2) from rotating.

2. The rotationally assembled fixing structure for the high-speed automotive electrical connector according to claim 1, wherein the at least one first anti-rotating feature (13) comprises a first lug (131), a second lug (132) and a first recess (133), the first lug (131) and the second lug (132) are arranged on a side wall, away from the second housing (2), of the at least one first non-return feature (12), and the first recess (133) is located between the first lug (131) and the second lug (132).

3. The rotationally assembled fixing structure for the high-speed automotive electrical connector according to claim 2, wherein an inner wall of the first housing (1) provided with the at least one hole (11) is provided with a plurality of second recesses (14), a plurality of first non-return features (12) are provided, one of the plurality of second recesses (14) is arranged between two adjacent first non-return features of the plurality of first non-return features (12), and the first recess (133) of one of the at least one first anti-rotating feature (13) is in communication with the second recess (14), adjacent to the second lug (132), of a same one of the at least one first anti-rotating feature (13).

4. The rotationally assembled fixing structure for the high-speed automotive electrical connector according to claim 2, wherein a side wall, connected to the second lug (132), of the at least one first non-return feature (12) is provided with a first bevel (121), and the first bevel (121) is arranged at an end, adjacent to the second lug (132), of the at least one first non-return feature (12).

5. The rotationally assembled fixing structure for the high-speed automotive electrical connector according to claim 1, wherein an outer wall of the at least one cylinder (21) is provided with at least one third lug (231), the at least one second non-return feature (232) is a non-return surface (234), and the non-return surface (234) is an end surface, away from the first housing (1), of the at least one third lug (231).

6. The rotationally assembled fixing structure for the high-speed automotive electrical connector according to claim 5, wherein an end surface of the non-return surface (234) is provided as a second bevel (237).

7. The rotationally assembled fixing structure for the high-speed automotive electrical connector according to claim 5, wherein a plurality of cylinders (21) are provided, an engaging member (23) is arranged among the plurality of cylinders (21), the engaging member (23) is provided with a plurality of third lugs (231), one of the plurality of third lugs (231) is arranged between two adjacent cylinders of the plurality of cylinders (21), and the third lug (231) extends out of the two adjacent cylinders (21).

8. The rotationally assembled fixing structure for the high-speed automotive electrical connector according to claim 5, wherein the at least one second anti-rotating feature (233) comprises a first anti-rotating surface (235) and a second anti-rotating surface (236), and the first anti-rotating surface (235) and the second anti-rotating surface (236) are respectively opposite side walls of a corresponding one of the plurality of third lugs (231).

9. The rotationally assembled fixing structure for the high-speed automotive electrical connector according to claim 5, wherein a side wall of each of plurality of the third lugs (231) away from one of the plurality of third lugs (231) opposite thereto comprises a third bevel (238) and an arc surface (239), and a height of an end portion, away from the arc surface (239), of the third bevel (238) is less than a height of an end portion, away from the third bevel (238), of the arc surface (239).

10. The rotationally assembled fixing structure for the high-speed automotive electrical connector according to claim 1, wherein a number of the at least one first non-return feature (12) is set corresponding to a number of the at least one second non-return feature (232).

11. The rotationally assembled fixing structure for a high-speed automotive electrical connector according to claim 1, wherein a number of the at least one first anti-rotating feature (13) is set corresponding to a number of the at least one second anti-rotating feature (233).
